(19) United States
(12) Patent Application Publication
(10) Pub. No.: US 2012/0259638 A1
(43) Pub. Date: Oct. 11, 2012

(54) APPARATUS AND METHOD FOR DETERMINING RELEVANCE OF INPUT SPEECH

(75) Inventor: OZLEM KALINLI, Burlingame, CA (US)

(73) Assignee: Sony Computer Entertainment Inc., Tokyo (JP)

(21) Appl. No.: 13/083,356

(22) Filed: Apr. 8, 2011

(51) Int. Cl. G10L 11/00

(52) U.S. Cl. 704/270; 704/E11.001

(57) ABSTRACT

Audio or visual orientation cues can be used to determine the relevance of input speech. The presence of a user's face may be identified during speech during an interval of time. One or more facial orientation characteristics associated with the user's face during the interval of time may be determined. In some cases, orientation characteristics for input sound can be determined. A relevance of the user's speech during the interval of time may be characterized based on the one or more orientation characteristics.

### FIELD OF THE INVENTION

Embodiments of the present invention are related to determination of the relevance of speech input in a computer program that includes speech recognition feature.

### BACKGROUND OF THE INVENTION

Many user-controlled programs use some form of speech recognition to facilitate interaction between the user and the program. Examples of programs implementing some form of speech recognition include: GPS systems, smart phone applications, computer programs, and video games. Often times, these speech recognition systems process all speech captured during operation of the program, regardless of the speech's relevance. For example, a GPS system that implements speech recognition may be configured to perform certain tasks when it recognizes specific commands made by the speaker. However, determining whether a given voice input (i.e., speech) constitutes a command requires the system to process every voice input made by the speaker.

Processing every voice input places a heavy workload on system resources, leading to overall inefficiency and a limited supply of hardware resource availability for other functions. Moreover, recovering from processing an irrelevant voice input is both difficult and time consuming for speech recognition systems. Likewise, having to process many irrelevant voice inputs in addition to relevant ones may cause confusion for the speech recognition system, leading to greater inaccuracy.

One prior art method for reducing the total voice inputs needed to be processed during operation of a given speech recognition system involves implementing push-to-talk. Push-to-talk gives the user control over when the speech recognition system captures voice inputs for processing. For example, a speech recognition system may employ a microphone to capture voice inputs. The user would then control the on/off functionality of the microphone (e.g., user presses a button to indicate that he is speaking a command to the system). While this does work to limit the amount of irrelevant voice inputs processed by the speech recognition system, it does so by burdening the user with having to control yet another aspect of the system.

It is within this context that embodiments of the present invention arise.

### BRIEF DESCRIPTION OF THE DRAWINGS

FIG. 1A is a flow/schematic diagram illustrating a method for determining relevance of speech of a user according to an embodiment of the present invention.

FIGS. 1B-1I are schematic diagrams illustrating examples of the use of eye gaze and face tracking in conjunction with embodiments of the present invention.

FIG. 2A-D are schematic diagrams illustrating facial orientation characteristic tracking setups according to embodiments of the present invention.

FIG. 2E is a schematic diagram illustrating a portable device that can utilize facial orientation tracking according to an embodiment of the present invention.

FIG. 3 is a block diagram illustrating an apparatus for determining relevance of speech of a user according to an embodiment of the present invention.

FIG. 4 is a block diagram illustrating an example of a cell processor implementation of an apparatus for determining relevance of speech of a user according to an embodiment of the present invention.

FIG. 5 illustrates an example of a non-transitory computer-readable storage medium with instructions for implementing determination of relevance of input speech according to an embodiment of the present invention.

### DESCRIPTION OF THE SPECIFIC EMBODIMENTS

The need for determining speech relevance arises when a user's speech acts as a control input for a given program. For example, this may occur in the context of a karaoke-type video game, where a user attempts to replicate the lyrics and melodies of popular songs. The program (game) will usually process all speech emanating from the user's mouth regardless of the user's intentions. Thus, speech intended to be used as a control input and speech not intended to be used as a control input will both be processed in the same manner. This leads to greater computational complexity and system inefficiency because irrelevant speech is being processed rather than discarded. This may also lead to reduced accuracy in program performance caused by the introduction of noisy voice inputs (i.e., irrelevant speech).

In embodiments of the present invention the relevancy of a given voice input may be determined without relying on a user's deliberate or conscious control over the capturing of speech. The relevance of a user's voice input may be characterized based on certain detectable cues that are given unconsciously by a speaker during speech. For example, the direction of the speaker's speech and the direction of the speaker's sight during speech may both provide tell-tale signs as to who or what is the target of the speaker's voice.

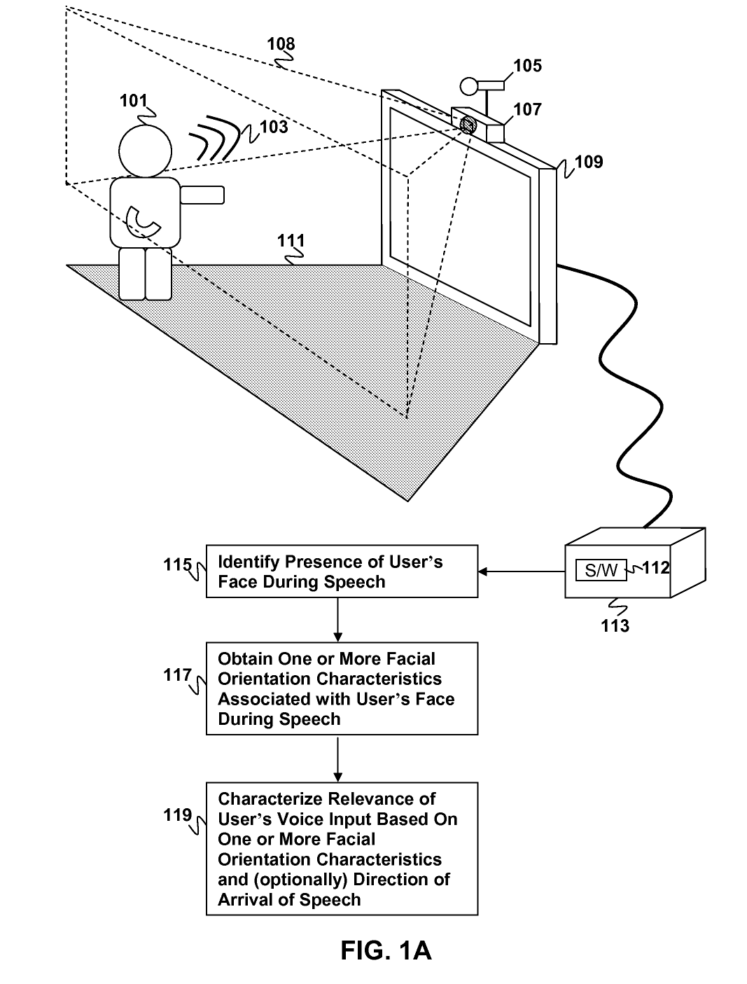

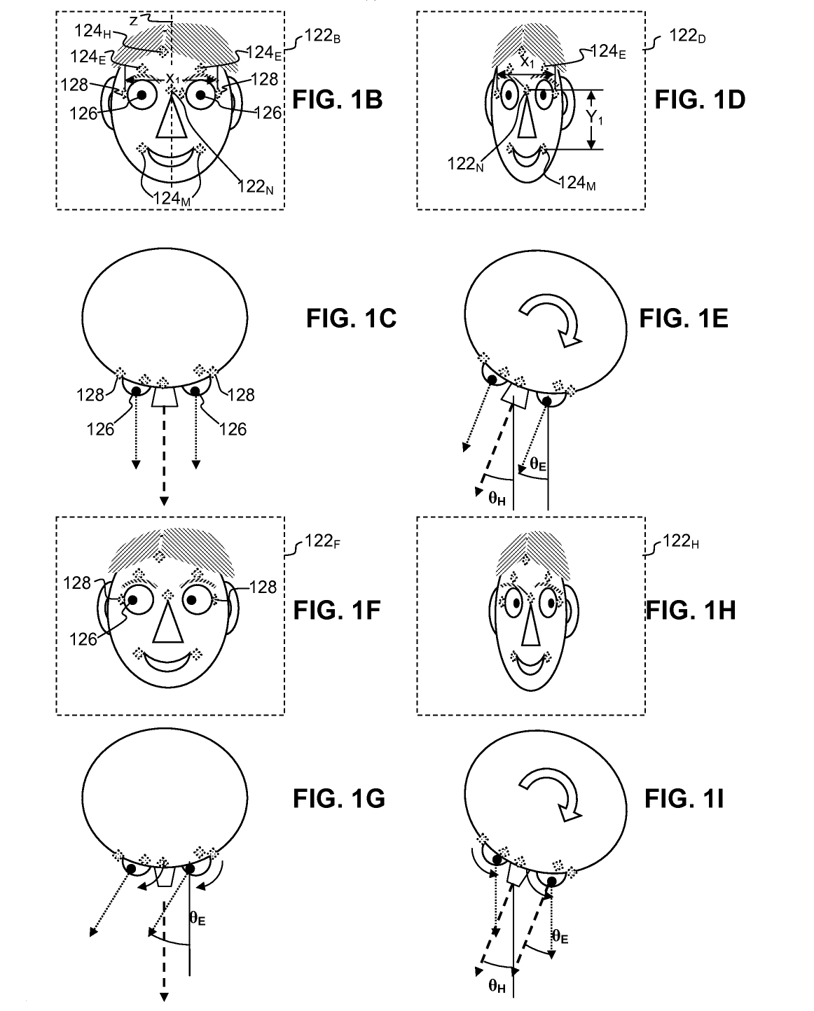

FIG. 1 is a schematic/flow diagram illustrating a method for determining relevance of voice inputs (i.e. speech) of a user according to an embodiment of the present invention. A user 101 may provide input to a program 112 being run on a processor 113 by using his speech 103 as a control input. The terms speech and voice input will be used interchangeably hereinafter to describe a user's auditory output in any situation. The processor 113 may be connected to a visual display 109, an image capture device 107 such as a digital camera, and microphone 105 to facilitate communication with a user 101. The visual display 109 may be configured to display content associated with the program running on the processor 113. The camera 107 may be configured to track certain facial orientation characteristics associated with the user 101 during speech. Likewise, the microphone 105 may be configured to capture the user's speech 103.

In embodiments of the present invention, whenever a user 101 engages in speech 103 during operation of the program, the processor 113 will seek to determine the relevance of that speech/voice input. By way of example, and not by way of limitation, the processor 113 can first analyze one or more images from the camera 107 to identify the presence of the user's face within an active area 111 associated with a program as indicated at 115. This may be accomplished, e.g., by using suitably configured image analysis software to track the location of the user 101 within a field of view 108 of the camera 107 and to identify the user's face within the field of view during some interval of time. Alternatively, the microphone 105 may include a microphone array having two or more separate-spaced apart microphones. In such cases, the processor 113 may be programmed with software capable of identifying the location of a source of sound, e.g., the user's voice. Such software may utilize direction of arrival (DOA) estimation techniques, such as beamforming, time delay of arrival estimation, frequency difference of arrival estimation etc., to determine the direction of a sound source relative to the microphone array. Such methods may be used to establish a listening zone for the microphone array that approximately corresponds to the field of view 108 of the camera 107. The processor can be configured to filter out sounds originating outside the listening zone. Some examples of such methods are described e.g., in commonly assigned U.S. Pat. No. 7,783,061, commonly assigned U.S. Pat. No. 7,809,145, and commonly-assigned U.S. Patent Application Publication number 2006/0239471, the entire contents of all three of which are incorporated herein by reference.

By way of example, and not by way of limitation, if the speech 103 originates from a location outside the field of view 108, the user's face will not be present and the speech 103 may be automatically characterized as being irrelevant and discarded before processing. If, however, the speech 103 originates from a location within the active area 111 (e.g., within the field of view 108 of the camera 107), the processor 113 may continue on to the next step in determining the relevancy of the user's speech.

Once the presence of the user's face has been identified, one or more facial orientation characteristics associated with the user's face during speech can be obtained during the interval of time as indicated at 117. Again, suitably configured image analysis software may be used to analyze one or more images of the user's face to determine the facial orientation characteristics. By way of example, and not by way of limitation, one of these facial orientation characteristics may be a user's head tilt angle. The user's head tilt angle refers to the angular displacement between a user's face during speech and a face that is directed exactly at the specified target (e.g., visual display, camera, etc.). The user's head tilt angle may refer to the vertical angular displacement, horizontal angular displacement, or a combination of the two. A user's head tilt angle provides information regarding his intent during speech. In most situations, a user will directly face his target when speaking, and as such the head tilt angle at which the user is speaking will help determine who/what the target of his speech is.

In addition to head tilt angle, another facial orientation characteristic that may be associated with the user's speech is his eye gaze direction. The user's eye gaze direction refers to the direction in which the user's eyes are facing during speech. A user's eye gaze direction may also provide information regarding his intent during speech. In most situations, a user will make eye contact with his target when speaking, and as such the user's eye gaze direction during speech will help determine who/what the target of his speech is.

These facial orientation characteristics may be tracked with one or more cameras and a microphone connected to the processor. More detailed explanations of examples of facial orientation characteristic tracking systems are provided below. In order to aid the system in obtaining facial orientation characteristics of a user, the program may initially require a user to register his facial profile prior to accessing the contents of the program. This gives the processor a baseline facial profile to compare future facial orientation characteristics to, which will ultimately result in a more accurate facial tracking process.

After facial orientation characteristics associated with a user's speech have been obtained, the relevancy of the user's speech may be characterized according to those facial orientation characteristics as indicated at 119. By way of example, and not by way of limitation, a user's speech may be characterized as irrelevant where one or more of the facial orientation characteristics obtained falls outside of an allowed range. For example, a program may set a maximum allowable head tilt angle of 45°, and so any speech made outside of a 45° head tilt angle will be characterized as irrelevant and discarded prior to processing. Similarly, the program may set a maximum angle of divergence from a specified target of 10° for the user's eye gaze direction, and so any speech made outside of a 10° divergent eye gaze direction will be characterized as irrelevant and discarded prior to processing. Relevance may also be characterized based on a combination of facial orientation characteristics. For example, speech made by a user whose head tilt angle falls outside of an allowed range, but whose eye gaze direction falls within the maximum angle of divergence may be characterized as relevant or speech made by a user whose head looks straight to the target, but whose eye gaze direction falls outside of the maximum angle of divergence may be characterized as irrelevant.

In addition to facial characteristics, certain embodiments of the invention may also take into account a direction of a source of speech in determining relevance of the speech at 119. Specifically, a microphone array may be used in conjunction with beamforming software to determine a direction of the source of speech 103 with respect to the microphone array. The beamforming software may also be used in conjunction with the microphone array and/or camera to determine a direction of the user with respect to the microphone array. If the two directions are very different, the software running on the processor may assign a relatively low relevance to the speech 103. Such embodiments may be useful for filtering out sounds originating from sources other than a relevant source, such as the user 101. It is noted that embodiments described herein can also work when there are multiple sources of speech in a scene captured by a camera (but only one is producing speech). As such, embodiments of the present invention are not limited to implementations in the user is the only source of speech in an image captured by the camera 107. Specifically, determining relevance of the speech at 119 may include discriminating among a plurality of sources of speech within an image captured by the image capture device 107.

In addition, the embodiments described herein can also work when there are multiple sources of speech captured by a microphone array (e.g., when multiple people are speaking) but only one source (e.g., the relevant user) is located within the field of view of the camera 107. Then the speech of user within the field of view can be detected as relevant. The microphone array can be used to steer and extract the sound only coming from the sound source located by the camera in the field of view. The processor 113 can implement a source separation algorithm with a priori information of the relevant user's location to extract relevant speech from the input to the microphone array. From another point of view, it can be also said that, speech coming from the sources outside of the field of view is considered irrelevant and ignored.

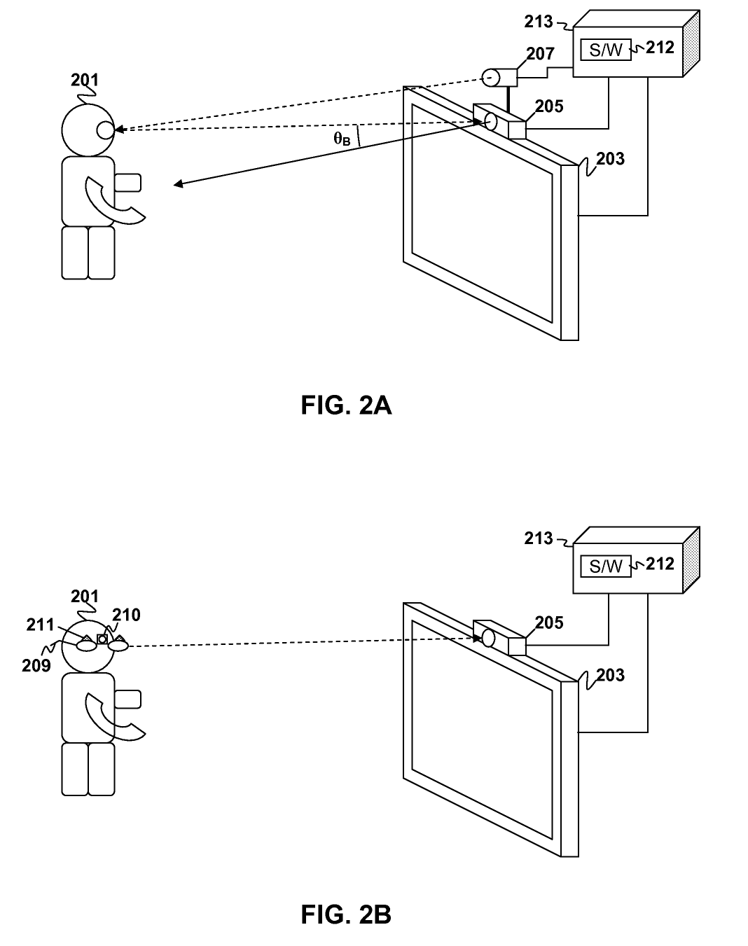

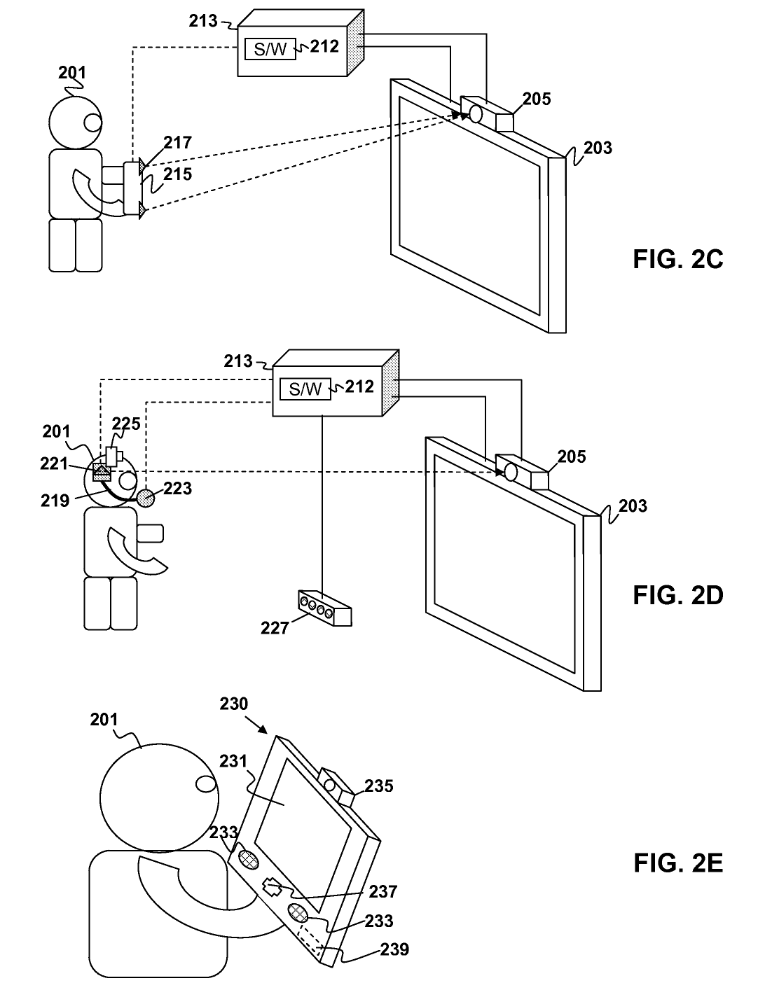

Each application/platform can decide relevance of speech based on extracted visual features (e.g., head tilt, eye gaze direction, etc) and acoustic features (e.g., localization information such as direction of arrival of sound, etc). For example, some applications/platforms may be stricter (i.e. hand-held devices like cell-phones, tablet PCs, or portable game devices, e.g., as shown in FIG. 2E) whereas some others may be less strict in terms of allowed deviation from the target (i.e. living room set-up with TV display as in FIG. 2A). In addition, data collected from subjects can be used to learn the mapping between these audio-visual features and relevance of speech using a machine learning algorithm such as decision trees, neural network etc., to make a better decision. Alternatively, instead of binary decision of relevant/irrelevant decision, a soft decision can be used in the system such that a likelihood score (i.e. a number between [0, 1]; 0 being irrelevant, 1 being relevant) estimated based on extracted audio-visual features can be sent to the speech recognition engine for weighting input speech frames. For example, a user's speech may grow less relevant as the user's head tilt angle increases. Similarly, the user's speech may grow less relevant as the user's eye gaze direction grows more divergent from the specified target. Thus, the weighted relevance of a user's speech can be used to determine how that speech is further processed or discarded prior to further processing.

By weighing the relevance of detected user speech prior to speech recognition processing, a system may save considerable hardware resources as well as improve the overall accuracy of speech recognition. Discarding irrelevant voice inputs decreases the workload of the processor and eliminates confusion involved with processing extraneous speech.

FIGS. 1B-1I illustrate examples of the use of facial orientation and eye gaze direction to determine the relevance of detected speech. As seen in FIG. 1B a face 120 of the user 101 may appear in an image 122_{B}. Image analysis software may identify reference points on the face 120. The software may characterize certain of these reference points, e.g., located at the corners of the mouth 124_{M}, the bridge of the nose 124_{N}, the part in the hair 124_{H}, and at the tops of the eyebrows 124_{E}, as being substantially fixed relative to the face 120. The software may also identify the pupils 126 and corners 128 of the user's eyes as reference points and determine the location of the pupils relative to the corners of the eyes. In some implementations, the centers of the user's eyes can be estimated from the locations of the pupils 126 and corners 128 of eyes. Then, the centers of eyes can be estimated and the locations of pupils can be compared with the estimated locations of the centers. In some implementations, face symmetry properties can be used.

The software can determine the user's facial characteristics, e.g., head tilt angle and eye gaze angle from analysis of the relative locations of the reference points and pupils 126. For example, the software may initialize the reference points 124_{E}, 124_{H}, 124_{M}, 124_{N}, 128 by having the user look straight at the camera and register the locations of the reference points and pupils 126 as initial values. The software can then initialize the head tilt and eye gaze angles to zero for these initial values. Subsequently, whenever the user looks straight ahead at the camera, as in FIG. 1B and the corresponding top view shown in FIG. 1C, the reference points 124_{E}, 124_{H}, 124_{M}, 124_{N}, 128 and pupils 126 should be at or near their initial values. The software may assign a high relevance to user speech when the head tilt and eye gaze angles are close to their initial values.

By way of example and not by way of limitation, the pose of a user's head may be estimated using five reference points, the outside corners 128 of each of the eyes, the outside corners 124_{M} of the mouth, and the tip of the nose (not shown). A facial symmetry axis may be found by connecting a line between a midpoint of the eyes (e.g., halfway between the eyes' outside corners 128) and a midpoint of the mouth (e.g., halfway between the mouth's outside corners 124_{M}). A facial direction can be determined under weak-perspective geometry from a 3D angle of the nose. Alternatively, the same five points can be used to determine the head pose from the normal to the plane, which can be found from planar skew-symmetry and a coarse estimate of the nose position. Further details of estimation of head pose can be found, e.g., in “Head Pose Estimation in Computer Vision: A Survey” by Erik Murphy, in IEEE TRANSACTIONS ON PATTERN ANALYSIS AND MACHINE INTELLIGENCE, Vol. 31, No. 4, April 2009, pp 607-626, the contents of which are incorporated herein by reference. Other examples of head pose estimation that can be used in conjunction with embodiments of the present invention are described in “Facial feature extraction and pose determination”, by Athanasios Nikolaidis Pattern Recognition, Vol. 33 (Jul. 7, 2000) pp. 1783-1791, the entire contents of which are incorporated herein by reference. Additional examples of head pose estimation that can be used in conjunction with embodiments of the present invention are described in “An Algorithm for Real-time Stereo Vision Implementation of Head Pose and Gaze Direction Measurement”, by Yoshio Matsumoto and Alexander Zelinsky in FG '00 Proceedings of the Fourth IEEE International Conference on Automatic Face and Gesture Recognition, 2000, pp 499-505, the entire contents of which are incorporated herein by reference. Further examples of head pose estimation that can be used in conjunction with embodiments of the present invention are described in “3D Face Pose Estimation from a Monocular Camera” by Qiang Ji and Ruong Hu in Image and Vision Computing, Vol. 20, Issue 7, 20 Feb. 2002, pp 499-511, the entire contents of which are incorporated herein by reference.

When the user tilts his head, the relative distances between the reference points in the image 122 may change depending upon the tilt angle. For example, if the user pivots his head to the right or left, about a vertical axis Z the horizontal distance x₁ between the corners 128 of the eyes may decrease, as shown in the image 122_{D} depicted in FIG. 1D. Other reference points may also work, or be easier to detect, depending on the particular head pose estimation algorithm being used. The amount change in the distance can be correlated to an angle of pivot θ_{H} as shown in the corresponding top view in FIG. 1E. It is noted that if the pivot is purely about the Z axis the vertical distance Y₁ between, say, the reference point at the bridge of the nose 124_{N} and the reference points at the corners of the mouth 124_{M}, would not be expected to change significantly. However, it would be reasonably expected for this distance y₁ to change if the user were to tilt his head upwards or downwards. It is further noted that the software may take the head pivot angle θ_{H} into account when determining the locations of the pupils 126 relative to the corners 128 of the eyes for gaze direction estimation. Alternatively the software may take the locations of the pupils 126 relative to the corners 128 of the eyes into account when determining head pivot angle θ_{H}. Such an implementation might be advantageous if gaze prediction is easier, e.g., with an infrared light source on a hand-held device, the pupils could be located relatively easily. In the example, shown in FIG. 1D and FIG. 1E, the user's eye gaze angle θ_{E} is more or less aligned with the user's head tilt angle. However, because of the pivoting of the user's head and the three-dimensional nature of the shape of the eyeballs, the positions of the pupils 126 will appear slightly shifted in the image 122_{D} compared to their positions in the initial image 122_{B}. The software may assign a relevance to user speech based on whether the head tilt angle θ_{H} and eye gaze angle θ_{E} are within some suitable range, e.g., close to their initial values, where the user is facing the camera or within some suitable range where the user 101 is facing the microphone 105.

In some situations, the user 101 may be facing the camera, but the user's eye gaze is directed elsewhere, e.g., as shown in FIG. 1F and the corresponding top view in FIG. 1G. In this example, the user's head is tilt angle θ_{H} is zero but the eye gaze angle θ_{E} is not. Instead, the user's eyeballs are rotated counterclockwise, as seen in FIG. 1G. Consequently, the reference points 124_{E}, 124_{H}, 124_{M}, 124_{N}, 128 are arranged as in FIG. 1B, but the pupils 126 are shifted to the left in the image 122_{F}. The program 112 may take this configuration of the user's face into account in determining whether any speech coming from the user 101 should be interpreted or can be ignored. For example, if the user is facing the microphone but looking away from it or looking at the microphone but facing away from it, the program 112 may assign a relatively lower probability to the likelihood that the user's speech should be recognized than if the user were both looking at the microphone and facing it.

It is noted that the user's head may pivot in one direction and the user's eyeballs may pivot in another direction. For example, as illustrated in FIG. 1H and FIG. 1I, the user 101 may pivot his head clockwise and rotate his eyeballs counterclockwise. Consequently, the reference points 124_{E}, 124_{H}, 124_{M}, 124_{N}, 128 are shifted as in FIG. 1E, but the pupils 126 are shifted to the right in the image 122_{H} shown in FIG. 1H. The program 112 may take this configuration into account in determining whether any speech coming from the user 101 should be interpreted or can be ignored.

As may be seen from the foregoing discussion it is possible to track certain user facial orientation characteristics using just a camera. However, many alternative forms of facial orientation characteristic tracking setups could also be used. FIGS. 2A-E illustrate examples of five facial orientation characteristic tracking systems that, among other possible systems, can be implemented according to embodiments of the present invention.

In FIG. 2A, the user 201 is facing a camera 205 and infrared light sensor 207, which are mounted on top of a visual display 203. To track the user's head tilt angle, the camera 205 may be configured to perform object segmentation (i.e., track user's separate body parts) and then estimate the user's head tilt angle from the information obtained. The camera 205 and infrared light sensor 207 are coupled to a processor 213 running software 213, which may be configured as described above. By way of example, and not by way of limitation, object segmentation may be accomplished using a motion model to describe how the image of a target might change in accordance to different possible movements of the object. It is noted that embodiments of the present invention may use more than one camera, for example, some implementations may use two cameras. One camera can provide a zoomed-out image of the field of view to locate the user, and a second camera can zoom-in and focus on the user's face to provide a close-up image for better head and gaze direction estimation.

A user's eye gaze direction may also be acquired using this setup. By way of example, and not by way of limitation, infrared light may be initially directed towards the user's eyes from the infrared light sensor 207 and the reflection captured by the camera 205. The information extracted from the reflected infrared light will allow a processor coupled to the camera 205 to determine an amount of eye rotation for the user. Video based eye trackers typically use the corneal reflection and the center of the pupil as features to track over time.

Thus, FIG. 2A illustrates a facial orientation characteristic tracking setup that is configured to track both the user's head tilt angle and eye gaze direction in accordance with an embodiment of the present invention. It is noted that, for the purposes of example, it has been assumed that the user is straight across from the display and camera. However, embodiments of the invention can be implemented even if the user is not straight across from the display 203 and/or camera 205. For example, the user 201 can be +45° or −45° to the right/left of display. As long as the user 201 is within field of view of the camera 205, the head angle θ_{H} and eye gaze θ_{E} can be estimated. Then, a normalized angle can be computed as a function of the location of user 201 with respect to the display 203 and/or camera 205 (e.g. body angle θ_{B} as shown in FIG. 2A), the head angle θ_{H} and eye gaze θ_{E}. For example, if the normalized angle is within allowed range, then speech can be accepted as relevant. By way of example and not by way of limitation, if the user 201, is located such that the body angle θ_{B} is +45° and if the head is turned at an angle θ_{H} of −45°, the user 201 is fixing the deviation of the body from the display 203 by turning his head, and this is almost as good as having the person looking straight at the display. Specifically, if, e.g., the user's gaze angle θ_{E} is zero (i.e., the user's pupil's are centered), the normalized angle (e.g., θ_{B}+θ_{H}+θ_{E}) is zero. The normalized angle as a function of head, body and gaze can be compared against a predetermined range to decide if speech is relevant.

FIG. 2B provides another facial orientation characteristic tracking setup. In FIG. 2B, the user 201 is facing a camera 205 mounted on top of a visual display 203. The user 201 is simultaneously wearing a pair of glasses 209 (e.g., a pair of 3D shutter glasses) with a pair of spaced-apart infrared (IR) light sources 211 (e.g., one IR LED on each lens of the glasses 209). The camera 205 may be configured to capture the infrared light emanating from the light sources 211, and then triangulate user's head tilt angle from the information obtained. Because the position of the light sources 211 will not vary significantly with respect to its position on the user's face, this setup will provide a relatively accurate estimation of the user's head tilt angle.

The glasses 209 may additionally include a camera 210 which can provide images to the processor 213 that can be used in conjunction with the software 212 to find the location of the visual display 203 or to estimate the size of the visual display 203. Gathering this information allows the system to normalize the user's facial orientation characteristic data so that calculation of those characteristics is independent of both the absolute locations of the display 203 and the user 201. Moreover, the addition of the camera will allow the system to more accurately estimate visible range. Thus, FIG. 2B illustrates an alternative setup for determining a user's head tilt angle according to an embodiment of the present invention. In some embodiments, separate cameras may be mounted to each lens of the glasses 209 facing toward the user's eyes to facilitate gaze tracking by obtaining images of the eyes showing the relative location of the pupil with respect to the centers or corners of the eyes. The relatively fixed position of the glasses 209 relative to the user's eyes facilitates tracking the user's eye gaze angle θ_{E} independent of tracking of the user's head orientation θ_{H}.

FIG. 2C provides a third facial orientation characteristic tracking setup. In FIG. 2C, the user 201 is facing a camera 205 mounted on top of a visual display 203. The user is also holding a controller 215 with one or more cameras 217 (e.g., one on each side) configured to facilitate interaction between the user 201 and the contents on the visual display 203.

The camera 217 may be configured to find the location of the visual display 203 or to estimate the size of the visual display 203. Gathering this information allows the system to normalize the user's facial orientation characteristic data so that calculation of those characteristics is independent of both the absolute locations of the display 203 and the user 201. Moreover, the addition of the cameras 217 to the controller 215 allows the system to more accurately estimate visible range.

It is important to note that the setup in FIG. 2C may be further combined with the setup in FIG. 2A (not shown in diagram) in order to track the user's eye gaze direction in addition to tracking the user's head tilt angle while making the system independent of display size and location. Because the user's eyes are unobstructed in this setup, his eye gaze direction may be obtained through the infrared light reflection and capturing process discussed above.

FIG. 2D provides yet another alternative facial orientation characteristic tracking setup. In FIG. 2D, the user 201 is facing a camera 205 mounted on top of a visual display 203. The user 201 is also wearing a headset 219 with infrared light sources 221 (e.g., one on each earpiece) and a microphone 223, the headset 219 being configured to facilitate interaction between the user 201 and the contents on the visual display 203. Much like the setup in FIG. 2B, the camera 205 may capture the infrared light paths emanating from the light sources 221 on the headset 219, and then triangulate the user's head tilt angle from the information obtained. Because the position of the headset 219 tends not to vary significantly with respect to its position on the user's face, this setup can provide a relatively accurate estimation of the user's head tilt angle.

In addition to tracking the user's head tilt angle using the infrared light sensors 221, the position of the user's head with respect to a specified target may also be tracked by a separate microphone array 227 that is not part of the headset 219. The microphone array 227 may be configured to facilitate determination of a magnitude and orientation of the user's speech, e.g., using suitably configured software 212 running on the processor 213. Examples of such methods are described e.g., in commonly assigned U.S. Pat. No. 7,783,061, commonly assigned U.S. Pat. No. 7,809,145, and commonly-assigned U.S. Patent Application Publication number 2006/0239471, the entire contents of all three of which are incorporated herein by reference.

A detailed explanation of directional tracking of a user's speech using thermographic information may be found in U.S. patent application Ser. No. 12/889,347, to Ruxin Chen and Steven Osman filed Sep. 23, 2010 entitled “BLOW TRACKING USER INTERFACE SYSTEM AND METHOD”, (Attorney Docket No. SCEA10042US00-I), which is herein incorporated by reference. By way of example, and not by way of limitation, the orientation of the user's speech can be determined using a thermal imaging camera to detect vibration patterns in the air around the user's mouth that correspond to the sounds of the user's voice during speech. A time evolution of the vibration patterns can be analyzed to determine a vector corresponding to a generalized direction of the user's speech.

Using both the position of the microphone array 227 with respect to the camera 205 and the direction of the user's speech with respect to the microphone array 227, the position of the user's head with respect to a specified target (e.g., display) may be calculated. To achieve greater accuracy in establishing a user's head tilt angle, the infrared reflection and directional tracking methods for determining head tilt angle may be combined.

The headset 219 may additionally include a camera 225 configured to find the location of the visual display 203 or to estimate the size of the visual display 203. Gathering this information allows the system to normalize the user's facial orientation characteristic data so that calculation of those characteristics is independent of both the absolute locations of the display 203 and the user 201. Moreover, the addition of the camera will allow the system to more accurately estimate visible range. In some embodiments, one or more cameras 225 may be mounted to the headset 219 facing toward the user's eyes to facilitate gaze tracking by obtaining images of the eyes showing the relative location of the pupil with respect to the centers or corners of the eyes. The relatively fixed position of the headset 219 (and therefore, the camera(s) 225) relative to the user's eyes facilitates tracking the user's eye gaze angle θ_{E} independent of tracking of the user's head orientation θ_{H}.

It is important to note that the setup in FIG. 2D may be combined with the setup in FIG. 2A (not shown in diagram) in order to track the user's eye gaze direction in addition to tracking the user's head tilt angle. Because the user's eyes are unobstructed in this setup, his eye gaze direction may be obtained through infrared light reflection and capturing process discussed above.

Embodiments of the present invention can also be implemented in hand-held devices, such as cell phones, tablet computers, personal digital assistants, portable internet devices, or portable game devices, among other examples. FIG. 2E illustrates one possible example of determining the relevance of speech in the context of a hand-held device 230. The device 230 generally includes a processor 239 which can be programmed with suitable software, e.g., as described above. The device 230 may include a display screen 231 and camera 235 coupled to the processor 239. One or more microphones 233 and control switches 237 may also be optionally coupled the processor 239. The microphone 233 may be part of a microphone array. The control switches 237 can be of any type normally used with the particular type of hand-held device. For example, if the device 230 is a cell phone, the control switches 237 may include a numeric keypad or alpha-numeric keypad commonly used in such device. Alternatively, if the device 230 is a portable game unit, the control switches 237 may include digital or analog joysticks, digital control switches, triggers, and the like. In some embodiments, the display screen 231 may be a touch screen interface and the functions of the control switches 237 may be implemented by the touch screen in conjunction with suitable software, hardware or firmware. The camera 235 may be configured to face the user 201 when the user looks at the display screen 231. The processor 239 may be programmed with software to implement head pose tracking and/or eye-gaze tracking. The processor may be further configured to utilize head pose tracking and/or eye-gaze tracking information in determining the relevance of speech detected by the microphone(s) 233, e.g., as discussed above.

It is noted that the display screen 231, microphone(s) 233, camera 235, control switches 237 and processor 239 may be mounted to a case that can be easily held in a user's hand or hands. In some embodiments, the device 230 may operate in conjunction with a pair of specialized glasses, which may have features in common with the glasses 209 shown in FIG. 2B and described hereinabove. Such glasses may communicate with the processor through a wireless or wired connection, e.g., a personal area network connection, such as a Bluetooth network connection. In some embodiments, the device 230 may be used in conjunction with a headset, which can have features in common with the headset 219 shown in FIG. 2D and described hereinabove. Such a headset may communicate with the processor through a wireless or wired connection, e.g., a personal area network connection, such as a Bluetooth network connection. The device 230 may include suitable antenna and transceiver to facilitate wireless network connection.

It is noted that the examples depicted in FIGS. 2A-2E are only a few examples of many setups that could be used to track a user's facial orientation characteristics during speech in embodiments of the present invention. Similarly, various body and other facial orientation characteristics in addition to the head tilt angle and eye gaze direction described above may be tracked to facilitate the characterization of relevancy of a user's speech.

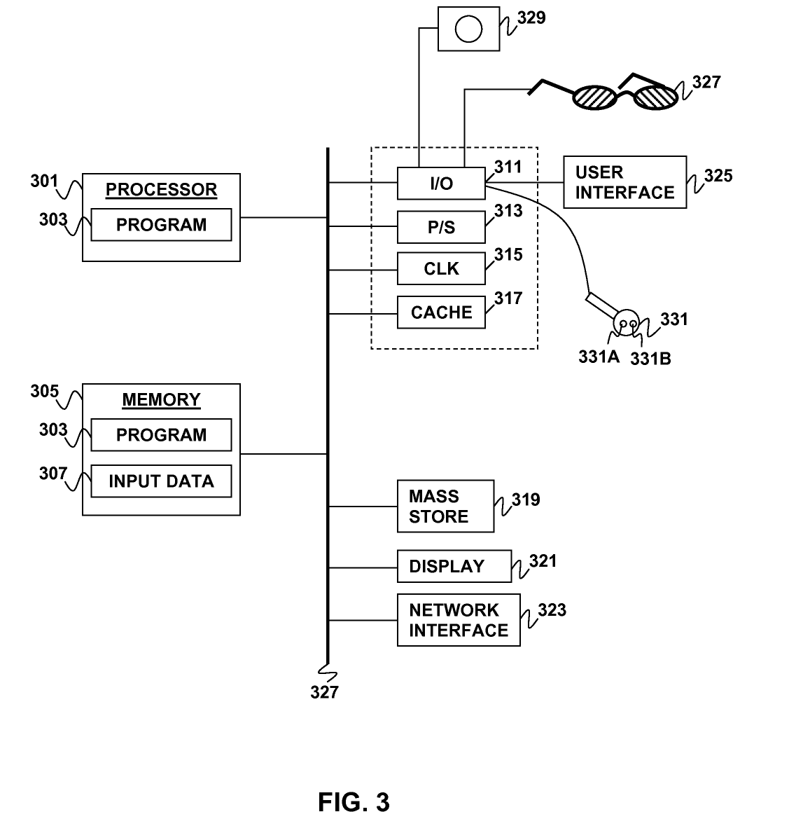

FIG. 3 illustrates a block diagram of a computer apparatus that may be used to implement a method for detecting irrelevant speech of a user according to an embodiment of the present invention. The apparatus 300 generally may include a processor module 301 and a memory 305. The processor module 301 may include one or more processor cores including, e.g., a central processor and one or more co-processors, to facilitate parallel processing.

The memory 305 may be in the form of an integrated circuit, e.g., RAM, DRAM, ROM, and the like. The memory 305 may also be a main memory that is accessible by all of the processor modules. In some embodiments, the processor module 301 may be a multi-core processor having separate local memories correspondingly associated with each core. A program 303 may be stored in the main memory 305 in the form of processor readable instructions that can be executed on the processor modules. The program 303 may be configured to perform estimation of relevance of voice inputs of a user. The program 303 may be written in any suitable processor readable language, e.g., C, C++, JAVA, Assembly, MATLAB, FORTRAN, and a number of other languages. The program 303 may implement face tracking and gaze tracking, e.g., as described above with respect to FIGS. 1A-1I.

Input data 307 may also be stored in the memory. Such input data 307 may include head tilt angles, eye gaze direction, or any other facial orientation characteristics associated with the user. Alternatively, the input data 307 can be in the form of a digitized video signal from a camera and/or a digitized audio signal from one or more microphones. The program 303 can use such data to compute head tilt angle and/or eye gaze direction. During execution of the program 303, portions of program code and/or data may be loaded into the memory or the local stores of processor cores for parallel processing by multiple processor cores.

The apparatus 300 may also include well-known support functions 309, such as input/output (I/O) elements 311, power supplies (P/S) 313, a clock (CLK) 315, and a cache 317. The apparatus 300 may optionally include a mass storage device 319 such as a disk drive, CD-ROM drive, tape drive, or the like to store programs and/or data. The device 300 may optionally include a display unit 321 and user interface unit 325 to facilitate interaction between the apparatus and a user. The display unit 321 may be in the form of a cathode ray tube (CRT) or flat panel screen that displays text, numerals, graphical symbols, or images. By way of example, and not by way of limitation, the display unit 321 may be in the form of a 3-D ready television set that displays text, numerals, graphical symbols or other visual objects as stereoscopic images to be perceived with a pair of 3-D viewing glasses 327, which can be coupled to the I/O elements 311. Stereoscopy refers to the enhancement of the illusion of depth in a two-dimensional image by presenting a slightly different image to each eye. As noted above, light sources or a camera may be mounted to the glasses 327. In some embodiments, separate cameras may be mounted to each lens of the glasses 327 facing the user's eyes to facilitate gaze tracking by obtaining images of the eyes showing the relative location of the pupil with respect to the centers or the corners of the eyes.

The user interface 325 may include a keyboard, mouse, joystick, light pen, or other device that may be used in conjunction with a graphical user interface (GUI). The apparatus 300 may also include a network interface 323 to enable the device to communicate with other devices over a network, such as the internet.

In some embodiments, the system may include an optional camera 329. The camera 329 can be coupled to the processor 301 via the I/O elements 311. As mentioned above, the camera 329 may be configured to track certain facial orientation characteristics associated with a given user during speech.

In some other embodiments, the system may also include an optional microphone 331, which may be a single microphone or a microphone array having two or more microphones 331A, 331B that can be spaced apart from each other by some known distance. The microphone 331 can be coupled to the processor 301 via the I/O elements 311. As discussed above, the microphone 331 may be configured to track direction of a given user's speech.

The components of the system 300, including the processor 301, memory 305, support functions 309, mass storage device 319, user interface 325, network interface 323, and display 321 may be operably connected to each other via one or more data buses 327. These components may be implemented in hardware, software, firmware, or some combination of two or more of these.

There are a number of additional ways to streamline parallel processing with multiple processors in the apparatus. For example, it is possible to “unroll” processing loops, e.g., by replicating code on two or more processor cores and having each processor core implement the code to process a different piece of data. Such an implementation may avoid a latency associated with setting up the loop. As applied to our invention, multiple processors could determine relevance of voice inputs from multiple users in parallel. Each user's facial orientation characteristics during speech could be obtained in parallel, and the characterization of relevancy for each user's speech could also be performed in parallel. The ability to process data in parallel saves valuable processing time, leading to a more efficient and streamlined system for detection of irrelevant voice inputs.

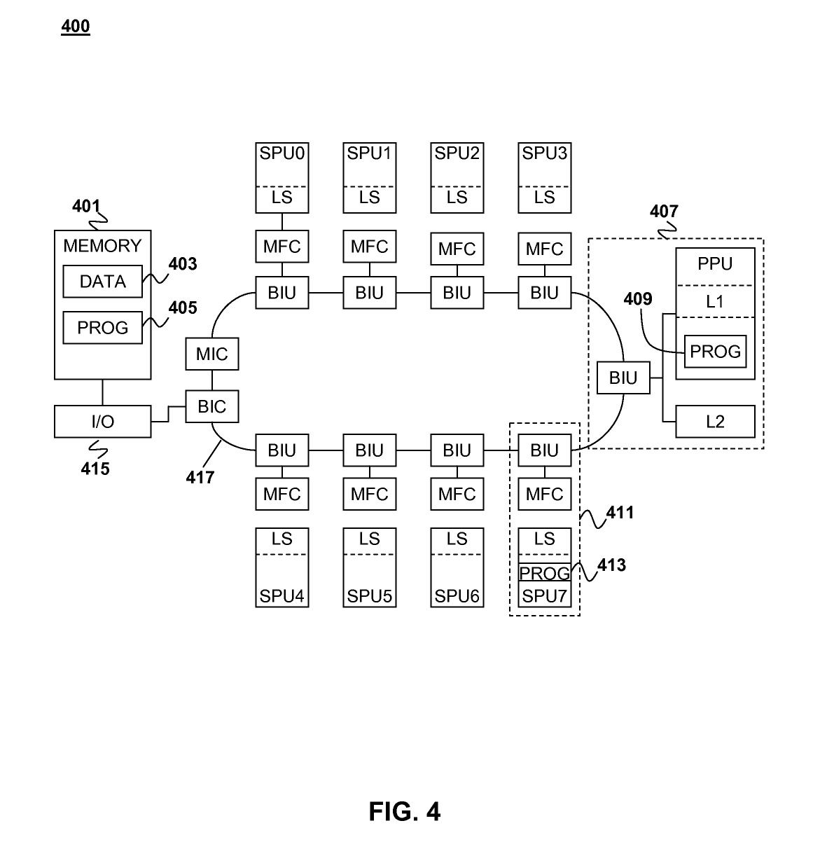

One example, among others of a processing system capable of implementing parallel processing on two or more processor elements is known as a cell processor. There are a number of different processor architectures that may be categorized as cell processors. By way of example, and without limitation, FIG. 4 illustrates a type of cell processor architecture. In this example, the cell processor 400 includes a main memory 401, a single power processor element (PPE) 407, and eight synergistic processor elements (SPE) 411. Alternatively, the cell processor may be configured with any number of SPEs. With respect to FIG. 4, the memory 401, PPE 407 and SPEs 411 can communicate with each other and with an I/O device 415 over a ring-type element interconnect bus 417. The memory 401 contains input data 403 having features in common with the input data described above and a program 405 having features in common with the program described above. At least one of the SPEs 411 may include in its local store (LS) speech relevance estimation instructions 413 and/or a portion of the input data that is to be processed in parallel, e.g., as described above. The PPE 407 may include in its L1 cache, determining relevance of voice input instructions 409 having features in common with the program described above. Instructions 405 and data 403 may also be stored in memory 401 for access by the SPE 411 and PPE 407 when needed.

By way of example, the PPE 407 may be a 64-bit PowerPC Processor Unit (PPU) with associated caches. The PPE 407 may include an optional vector multimedia extension unit. Each SPE 411 includes a synergistic processor unit (SPU) and a local store (LS). In some implementations, the local store may have a capacity of e.g., about 256 kilobytes of memory for programs and data. The SPUs are less complex computational units than the PPU, in that they typically do not perform system management functions. The SPUs may have a single instruction, multiple data (SIMD) capability and typically process data and initiate any required data transfers (subject to access properties set up by a PPE) in order to perform their allocated tasks. The SPUs allow the system to implement applications that require a higher computational unit density and can effectively use the provided instruction set. A significant number of SPUs in a system, managed by the PPE allows for cost-effective processing over a wide range of applications. By way of example, the cell processor may be characterized by an architecture known as Cell Broadband Engine Architecture (CBEA). In CBEA-compliant architecture, multiple PPEs may be combined into a PPE group and multiple SPEs may be combined into an SPE group. For purposes of example, the cell processor is depicted as having only a single SPE group and a single PPE group with a single SPE and a single PPE. Alternatively, a cell processor can include multiple groups of power processor elements (PPE groups) and multiple groups of synergistic processor elements (SPE groups). CBEA-compliant processors are described in detail, e.g., in Cell Broadband Engine Architecture, which is available online at: http://www-306.ibm.comichips/techlib/techlib.nsf/techdocs/1AEEE1270EA277638725706000E61B A/$file/CBEA_{—}01_pub.pdf, which is incorporated herein by reference.

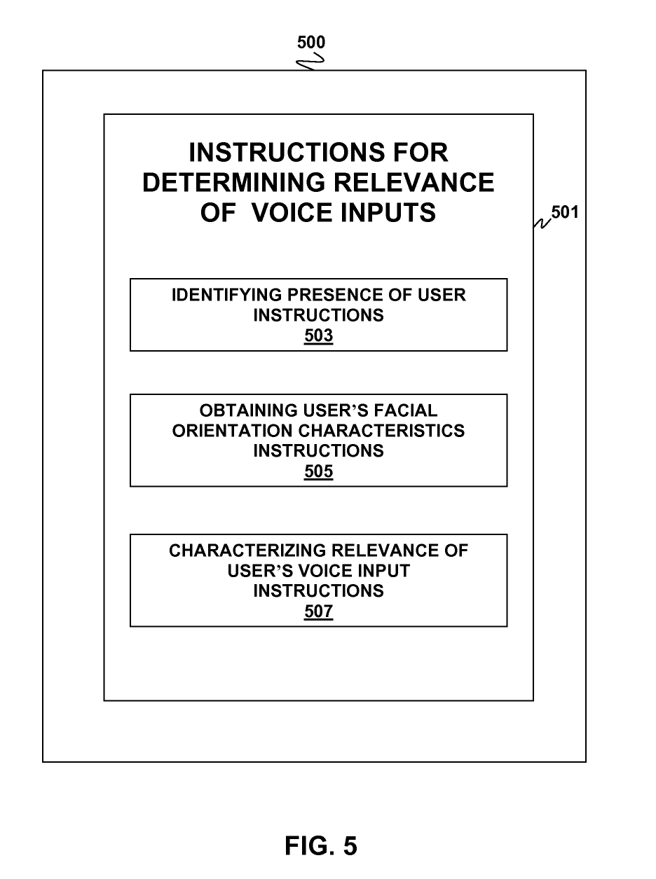

According to another embodiment, instructions for determining relevance of voice inputs may be stored in a computer readable storage medium. By way of example, and not by way of limitation, FIG. 5 illustrates an example of a non-transitory computer readable storage medium 500 in accordance with an embodiment of the present invention. The storage medium 500 contains computer-readable instructions stored in a format that can be retrieved, interpreted, and executed by a computer processing device. By way of example, and not by way of limitation, the computer-readable storage medium 500 may be a computer-readable memory, such as random access memory (RAM) or read only memory (ROM), a computer readable storage disk for a fixed disk drive (e.g., a hard disk drive), or a removable disk drive. In addition, the computer-readable storage medium 500 may be a flash memory device, a computer-readable tape, a CD-ROM, a DVD-ROM, a Blu-Ray, HD-DVD, UMD, or other optical storage medium.

The storage medium 500 contains determining relevance of voice input instructions 501 configured to facilitate estimation of relevance of voice inputs. The determining relevance of voice input instructions 501 may be configured to implement determination of relevance of voice inputs in accordance with the method described above with respect to FIG. 1. In particular, the determining relevance of voice input instructions 501 may include identifying presence of user instructions 503 that are used to identify whether speech is coming from a person positioned within an active area. If the speech is coming from a person positioned outside of the active area, it is immediately characterized as irrelevant, as discussed above.

The determining relevance of voice input instructions 501 may also include obtaining user's facial orientation characteristics instructions 505 that are used to obtain certain facial orientation characteristics of a user (or users) during speech. These facial orientation characteristics act as cues to help determine whether a user's speech is directed at a specified target. By way of example, and not by way of limitation, these facial orientation characteristics may include a user's head tilt angle and eye gaze direction, as discussed above.

The determining relevance of voice input instructions 501 may also include characterizing relevancy of user's voice input instructions 507 that are used to characterize the relevancy of a user's speech based on his audio (i.e. direction of speech) and visual (i.e. facial orientation) characteristics. A user's speech may be characterized as irrelevant where one or more of the facial orientation characteristics fall outside an allowed range. Alternatively, the relevancy of a user's speech may be weighted according to each facial orientation characteristic's divergence from an allowed range.

While the above is a complete description of the preferred embodiment of the present invention, it is possible to use various alternatives, modifications, and equivalents. Therefore, the scope of the present invention should be determined not with reference to the above description, but should, instead, be determined with reference to the appended claims, along with their full scope of equivalents. Any feature described herein, whether preferred or not, may be combined with any other feature described herein, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly received in a given claim using the phrase “means for”.

What is claimed is:

1. A method for determining relevance of input speech, comprising:
a) identifying the presence of the user's face during speech in an interval of time;
b) obtaining one or more facial orientation characteristics associated with the user's face during the interval of time; and
c) characterizing a relevance of the speech during the interval of time based on the one or more orientation characteristics obtained in b).

2. The method of claim 1, wherein obtaining the one or more facial orientation characteristics in b) involves tracking the user's facial orientation characteristics using a camera.

3. The method of claim 2, wherein obtaining the one or more facial orientation characteristics in b) further involves tracking the user's facial orientation characteristics using infrared lights.

4. The method of claim 1, wherein obtaining the one or more orientation characteristics in b) involves tracking the user's facial orientation characteristics using a microphone.

5. The method of claim 1, wherein the one or more facial orientation characteristics in b) includes a head tilt angle.

6. The method of claim 1, wherein the one or more facial orientation characteristics in b) includes an eye gaze direction.

7. The method of claim 1, wherein c) involves characterizing the user's speech as irrelevant where one or more of the facial orientation characteristics fall outside an allowed range.

8. The method of claim 1, wherein c) involves weighing the relevance of the user's speech based on one or more of the facial orientation characteristics' divergence from an allowed range.

9. The method of claim 1, further comprising registering a profile of the user's face prior to obtaining one or more facial orientation characteristics associated with the user's face during speech.

10. The method of claim 1, further comprising determining a direction of a source of the speech and wherein c) includes taking the direction of the source of speech in characterizing the relevance of the speech.

11. The method of claim 1, wherein c) includes discriminating among a plurality of sources of speech within an image captured by an image capture device.

12. An apparatus for determining relevance of speech, comprising:
a processor;
a memory; and
computer coded instructions embodied in the memory and executable by the processor, wherein the computer coded instructions are configured to implement a method for determining relevance of speech of a user, comprising:
a) identifying the presence of the user's face during speech in an interval of time;
b) obtaining one or more facial orientation characteristics associated with the user's face during speech during the interval of time;
c) characterizing the relevance of the user's speech during the interval of time based on the one or more orientation characteristics obtained in b).

13. The apparatus in claim 12, further comprising a camera configured to obtain the one or more orientation characteristics in b).

14. The apparatus in claim 12, further comprising one or more infrared lights configured to obtain the one or more orientation characteristics in b).

15. The apparatus in claim 12, further comprising a microphone configured to obtain the one or more orientation characteristics in b).

16. A computer program product comprising:
a non-transitory, computer-readable storage medium having computer readable program code embodied in said medium for determining relevance speech, said computer program having:
a) computer readable program code means for identifying the presence of the user's face during speech in an interval of time;
b) computer readable program code means for obtaining one or more facial orientation characteristics associated with the user's face during the interval of time;
c) computer readable program code means for characterizing the relevance of the user's speech based on the one or more orientation characteristics obtained in b).
